(19) United States
(12) Patent Application Publication
(10) Pub. No.: US 2025/0035855 A1
(43) Pub. Date: Jan. 30, 2025

(54) FIBER WIRE FIXATION STRUCTURE, OPTICAL SUBMARINE REPEATER, AND METHOD OF ASSEMBLING FIBER WIRE FIXATION STRUCTURE

(71) Applicant: NEC Corporation, Tokyo (JP)

(72) Inventor: Mamoru OGURO, Tokyo (JP)

(73) Assignee: NEC Corporation, Tokyo (JP)

(21) Appl. No.: 18/754,384

(22) Filed: Jun. 26, 2024

(30) Foreign Application Priority Data
Jul. 25, 2023 (JP) 2023-110419

(51) Int. Cl. G02B 6/36; H04B 10/29

(52) U.S. Cl. CPC G02B 6/3616; H04B 10/29

(57) ABSTRACT

A fiber wire fixation structure is disclosed. The fiber wire fixation structure includes: a rod-shaped cushion having a plurality of slits each extending in a length direction on an outer circumference of the rod-shaped cushion, the plurality of slits being configured so that a fiber wire is allowed to be inserted into each of the plurality of slits; and a cushion fixing part having a hollow tube-shaped structure, the cushion fixing part being configured so that the cushion is pressed and fixed from the outer circumference of the cushion when the cushion is pressed into a hollow space of the cushion fixing part to a predetermined position in the cushion fixing part.

### INCORPORATION BY REFERENCE

This application is based upon and claims the benefit of priority from Japanese patent application No. 2023-110419, filed on Jul. 5, 2023, the disclosure of which is incorporated herein in its entirety by reference.

### TECHNICAL FIELD

The present disclosure relates to a fiber wire fixation structure, an optical submarine repeater, and a method of assembling a fiber wire fixation structure.

### BACKGROUND ART

In recent years, a demand for international communications, which includes intercontinental communications, has been expanding rapidly. In addition, a recent increase in data traffic has led to a rapid spread of optical communications. Here, in order to accommodate large-capacity transmission methods, there is a demand for high-performance communication devices for optical submarine cables. Since such optical submarine cables are quite long, optical submarine repeaters are installed at regular intervals to amplify optical signals (for example, JP2006-78677A).

In an optical submarine repeater, a plurality of fiber wires extending from an upstream optical submarine cable and a plurality of fiber wires extending from a downstream optical submarine cable are housed. In order to house the fiber wires from the optical submarine cables within the optical submarine repeater, a stable fixation structure that achieves low loss is required. Here, in order to prevent the occurrence of a kink due to pulling on the fiber wires drawn out from the optical submarine repeater to the opposite optical submarine cable, it is necessary to securely fix these fiber wire within the optical submarine repeater.

### SUMMARY

As a method of fixing fiber wires, for example, a structure in which a plurality of fiber wires is sandwiched between two cushions from side surfaces thereof to compress and fix them in a housing is conceivable. However, in a case where the plurality of fiber wires is simply arranged between the two cushions, there is a risk that any two fiber wires thereof may cross each other between the cushions. In such a case, there is a risk that an excessive pressure from the cushions may cause microbending at a point where the two fiber wires cross, which may result in a loss (that is, a microbending loss).

The present disclosure is made in order to solve such a problem, and an example object of the present disclosure is to provide a fiber wire fixation structure, an optical submarine repeater, and a method of assembling a fiber wire fixation structure capable of reliably preventing a plurality of fiber wires from being compressed and fixed in a crossed state thereof.

In a first example aspect of the present disclosure, a fiber wire fixation structure includes:
a rod-shaped cushion having a plurality of slits each extending in a length direction on an outer circumference of the rod-shaped cushion, the plurality of slits being configured so that a fiber wire is allowed to be inserted into each of the plurality of slits; and
a cushion fixing part having a hollow tube-shaped structure, the cushion fixing part being configured so that the cushion is pressed and fixed from the outer circumference of the cushion when the cushion is pressed into a hollow space of the cushion fixing part to a predetermined position in the cushion fixing part.

In a second example aspect of the present disclosure, an optical submarine repeater includes:
a housing having a shape of a rectangular prism, one side of the housing serving as a lid;
the fiber wire fixation structure described in the first example aspect;
two cushions having a main surface that is a same main surface of the lid of the housing,
wherein the fiber wire fixation structure is fixed within the housing in a state where the fiber wire fixation structure is pressed by the two cushions from two directions with respect to a direction perpendicular to the main surface of the lid.

In a third example aspect of the present disclosure, a method of assembling a fiber wire fixation structure includes:
respectively inserting fiber wires into a plurality of slits each extending in a length direction of a rod-shaped cushion, the plurality of slits being provided on an outer circumference of the rod-shaped cushion; and
pressing the cushion into a cushion fixing part having a hollow tube-shaped structure to a predetermined position in the cushion fixing part in a state where the plurality of fiber wires is respectively inserted into the plurality of slits.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a schematic cross-sectional view of an optical submarine repeater according to the present disclosure;

FIG. 2 is a schematic cross-sectional view of a fiber wire fixation structure according to the present disclosure;

FIG. 3A is a front view of a fiber cushion before fiber wires according to the present disclosure are fixed;

FIG. 3B is a perspective view of the fiber cushion before the fiber wires according to the present disclosure are fixed;

FIG. 4 is a view illustrating a modification example of the fiber cushion in the fiber wire fixation structure according to the present disclosure;

FIG. 5 is a front view of a cushion fixing part before the fiber wires according to the present disclosure are fixed;

FIG. 6 is a view illustrating a fiber wire arranging process in a method of assembling the fiber wire fixation structure according to the present disclosure;

FIG. 7 is a view illustrating a state in a preparation stage of a fiber cushion fixing process in the method of assembling the fiber wire fixation structure according to the present disclosure; and

FIG. 8 is a view illustrating a state after the fiber cushion fixing process in the method of assembling the fiber wire fixation structure according to the present disclosure.

### EXAMPLE EMBODIMENT

### Example Embodiment

Hereinafter, an example embodiment according to the present invention will be described with reference to the drawings. However, the present disclosure according to the claims is not limited to the following example embodiments. Further, not all of the configurations explained in the present example embodiment are essential as means for solving the problem. For clarity of explanation, the following description and the drawings are omitted and simplified as appropriate. In the drawings, the same elements are denoted by the same reference numerals, and redundant explanations thereof will be omitted as necessary.

### <Optical Submarine Repeater>

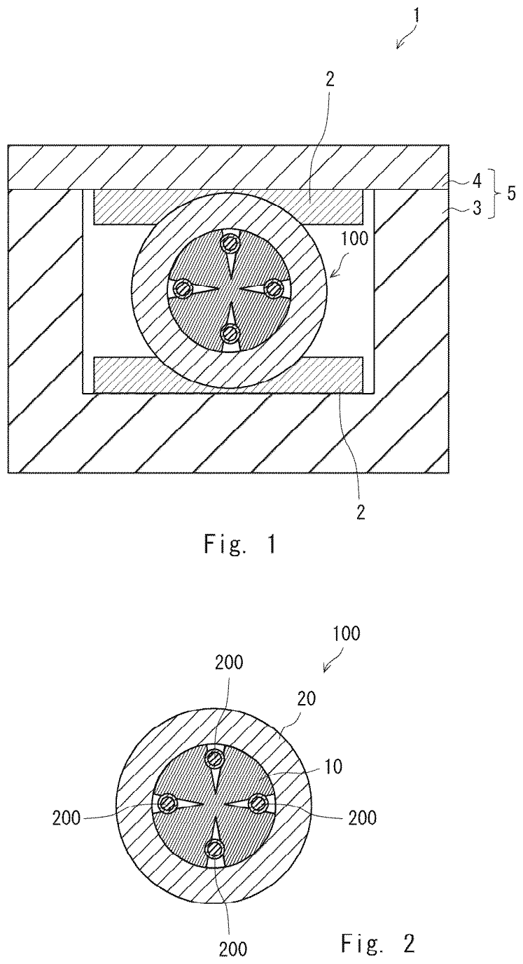

First, a configuration of an optical submarine repeater according to the present disclosure will be described with respect to FIG. 1. FIG. 1 is a schematic cross-sectional view of an optical submarine repeater 1 according to the present disclosure. The optical submarine repeater 1 according to the present example embodiment is one obtained by housing a fiber wire fixation structure 100 (will be described later) in a housing body 3 to fix in within a housing 5 by pressing with a lid 4. As illustrated in FIG. 1, the optical submarine repeater 1 includes the fiber wire fixation structure 100, two repeater cushions 2, and the housing 5 consisting of the housing body 3 and the lid 4.

The housing 5 has a shape of a rectangular prism, but the shape of the housing 5 is not limited to this shape. The housing 5 may have any shape, such as a cylindrical shape, as long as the housing 5 can firmly fix the fiber wire fixation structure 100. In a case where the housing 5 has any of the other shapes, the number of repeater cushions 2 or a shape thereof may be adjusted to match the shape.

As described above, the housing 5 has the housing body 3 and the lid 4. The housing body 3 has a box shape without a lid. The lid 4 is configured as one side of the housing 5. When the optical submarine repeater 1 is in a completed state, the lid 4 is firmly fixed onto the housing body 3 to seal the inside of the optical submarine repeater 1 so that it can resist high hydraulic pressure at the bottom of the sea.

In the present example embodiment, each of the two repeater cushions 2 has a flat plate-like shape having two main surfaces. The two repeater cushions 2 are respectively disposed on the bottom and the top of the housing 5 via the fiber wire fixation structure 100 so that a direction of the main surfaces of each of the two repeater cushions 2 are in the same direction as a main surface of the lid 4 of the housing 5.

The material of the repeater cushions 2 may be any material, such as rubber or sponge, as long as the fiber wire fixation structure 100 an be firmly fixed therebetween.

The fiber wire fixation structure 100 (will be described later) is to be installed inside the optical submarine repeater 1. Specifically, the fiber wire fixation structure 100 is fixed in the housing 5 in a state where the fiber wire fixation structure 100 is pressed by the two repeater cushions 2, 2 from two directions, that is, above and below in FIG. 1 with respect to a direction perpendicular to the main surface of the lid 4.

### <Fiber Wire Fixation Structure>

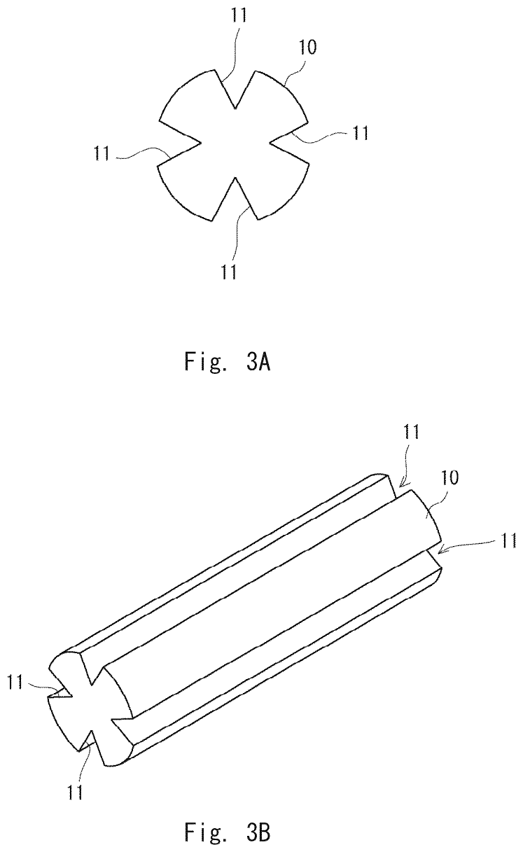

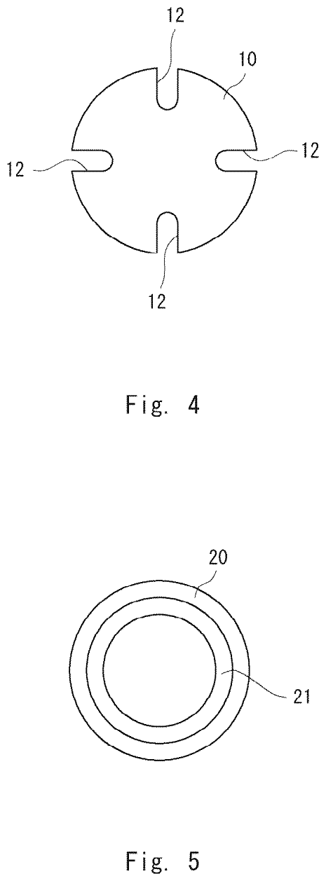

Next, a configuration of the fiber wire fixation structure 100 according to the present disclosure will be described with reference to FIGS. 2 to 5. FIG. 2 is a schematic cross-sectional view of the fiber wire fixation structure 100 according to the present disclosure. FIGS. 3A and 3B are respectively a front view and a perspective view of a fiber cushion 10 before the fiber wires 200 according to the present disclosure are fixed. FIG. 4 is a view illustrating a modification example of the fiber cushion 10 in the fiber wire fixation structure 100 according to the present disclosure. FIG. 5 is a front view of a cushion fixing part 20 before the fiber wires 200 according to the present disclosure are fixed. Note that a cross section of the fiber wire fixation structure 100 illustrated in FIG. 2 corresponds to a cross section of the fiber wire fixation structure 100 illustrated in FIG. 1.

The fiber wire fixation structure 100 according to the present example embodiment is to be fixed in the housing 5 of the optical submarine repeater 1, whereby the plurality of fiber wires 200 are fixed in the optical submarine repeater 1. As illustrated in FIG. 2, the fiber wire fixation structure 100 includes the fiber cushion 10 and the cushion fixing part 20.

As illustrated in FIG. 3, the fiber cushion 10 is a rod-shaped cushion having a cylindrical shape, and has a plurality of slits 11 each extending in a length direction on an outer circumference of the fiber cushion 10. In the present example embodiment, in order for the fiber wire fixation structure 100 to fix four fiber wires 200 so as to be spaced from each other, the fiber cushion 10 has four slits 11 at equal intervals.

Each of the slits 11 has an opening whose cross section is a substantially V shape. As will be described later, in an assembling process of the fiber wire fixation structure 100, the fiber wires 200 are respectively inserted into the openings of the slits 11.

Note that a cross-sectional shape of the opening of each slit 11 is not limited to the substantially V shape. For example, as illustrated in FIG. 4, the cross-sectional shape may be a substantially U shape. That is, the fiber cushion 10 may have a plurality of slits 12 each extending in a length direction thereof instead of the slits 11. In this case, a bottom portion of the substantially U shape, that is, a curved portion of the slit 12 in a direction toward the center of the fiber cushion 10 has a size that approximately matches an outer circumference of the fiber wire 200. By configuring the slits 12 in this manner, the outer circumference of the fiber wire 200 comes into contact with an inner surface of the slit 12 more extensively as compared with the slits 11. This makes it possible to distribute loads from the fiber cushion 10 onto the fiber wires 200 more evenly.

The material of the fiber cushion 10 may be any material as long as each of the fiber wires 200 is firmly fixed after the fiber wire fixation structure 100 is assembled and an excessive pressure is not applied to the fiber wire 200. As well as the repeater cushion 2, the material of the fiber cushion 10 may be rubber or sponge, for example.

Note that the case where the fiber cushion 10 has the cylindrical shape has been described in the present example embodiment, the shape of the fiber cushion 10 is not limited to this shape. As long as the loads onto the fiber wires 200 are approximately uniform after the fiber wire fixation structure 100 is assembled, the fiber cushion 10 may have a prismatic shape such as a square depending upon the number of fiber wires 200 to be fixed, for example. More preferably, the fiber cushion 10 may have a regular polygonal prism shape.

As illustrated in FIGS. 2 and 5, the cushion fixing part 20 is a hollow tube-shaped (or ring-shaped) component having a hollow cylindrical shape. Further, a tapered part 21 is provided at one end of the cushion fixing part 20 in an axial direction thereof. The tapered part 21 gradually narrows from the one end toward the other end in the axial direction thereof (see FIG. 7). As will be described later, the tapered part 21 is used when the fiber cushion 10 is inserted into a hollow space of the cushion fixing part 20.

Note that the material of the cushion fixing part 20 is not limited particularly, but the material of the cushion fixing part 20 may have strength capable of pressing the fiber cushion 10 into the hollow space. As will be described later, the fiber wire fixation structure 100 is configured so that the fiber cushion 10 is pressed and fixed from the outer circumference of the fiber cushion 10 by pressing the fiber cushion 10 into the hollow space of the cushion fixing part 20 to a predetermined position in the hollow space by using the tapered part 21.

The fiber wires 200 inserted in the plurality of slits 11 or 12 are respectively fixed in the slits 11 or 12 so as to be spaced from each other by being pressed from the cross section (the inner surfaces) of the corresponding slits 11 or 12 without touching an inner wall of the cushion fixing part 20 in a state where the outer circumference of the fiber cushion 10 is pressed and the fiber cushion 10 is fixed in the cushion fixing part 20.

### <Method of Assembling Fiber Wire Fixation Structure>

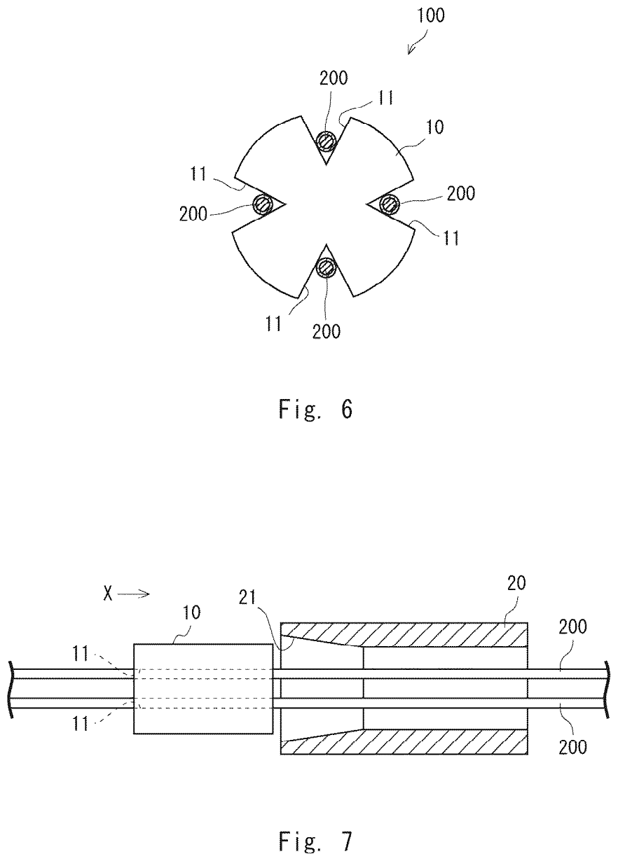

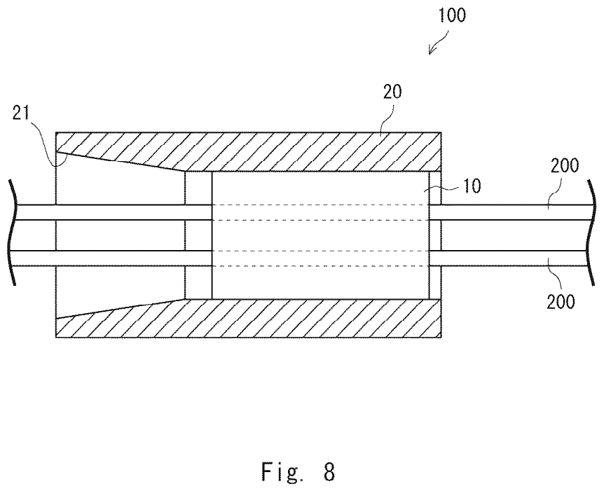

Next, a method of assembling a fiber wire fixation structure according to the present disclosure will be described with reference to FIGS. 6 to 8. FIG. 6 is a view illustrating a fiber wire arranging process in the method of assembling the fiber wire fixation structure 100 according to the present disclosure. FIG. 7 is a view illustrating a state in a preparation stage of a fiber cushion fixing process in the method of assembling the fiber wire fixation structure 100 according to the present disclosure. FIG. 8 is a view illustrating a state after the fiber cushion fixing process in the method of assembling the fiber wire fixation structure 100 according to the present disclosure. In the present example embodiment, a case where the fiber cushion 10 having the slits 11 illustrated in FIG. 3 is used will be described.

The method of assembling the fiber wire fixation structure 100 at least includes a fiber wire arranging process and a fiber cushion fixing process. In the fiber wire arranging process, a plurality of fiber wires 200 and a fiber cushion 10 are first prepared. Then, as illustrated in FIG. 6, the plurality of fiber wires 200 is disposed on the fiber cushion 10 by respectively inserting the fiber wires 200 in slits 11 of the fiber cushion 10.

Subsequently, in the fiber cushion fixing process, a cushion fixing part 20 is first prepared. At this time, as illustrated in FIG. 7, the fiber cushion 10 in which the plurality of fiber wires 200 is inserted and the cushion fixing part 20 are arranged so that a tapered part 21 of the cushion fixing part 20 faces the fiber cushion 10. In this case, the plurality of fiber wires 200 disposed in the slits 11 is in a state of passing through a hollow space of the cushion fixing part 20.

Then, in a state where the plurality of fiber wires 200 is respectively inserted in the plurality of slits 11, the fiber cushion 10 in which the plurality of fiber wires 200 is inserted is moved in an X direction illustrated in FIG. 7 while fixing the cushion fixing part 20. When one end of the fiber cushion 10 in a length direction thereof comes into contact with the tapered part 21 of the cushion fixing part 20, the fiber cushion 10 is moved while the one end of the fiber cushion 10 is compressed so as to fit along an inner surface of the tapered part 21.

Finally, as illustrated in FIG. 8, the fiber cushion 10 in which the plurality of fiber wires 200 is pressed into a hollow space of the cushion fixing part 20 to a predetermined position of the cushion fixing part 20. Then, the assembling of the fiber wire fixation structure 100 is completed. As a result, the fiber cushion 10 is compressed substantially evenly, whereby each fiber wire 200 is individually fixed. Here, the predetermined position means a position where the fiber cushion 10 has completely passed through the tapered part 21 and the entire outer circumference of the fiber cushion 10 is pressed by an inner surface of the cushion fixing part 20. For this reason, a length of the cushion fixing part 20 excluding the tapered part 21 is set to a length that is longer than a length of the fiber cushion 10 by a predetermined length.

Note that it is not illustrated, but a method of assembling an optical submarine repeater 1 is as follows. That is, as illustrated in FIG. 1, after further preparing two repeater cushions 2 and a housing body 3, one repeater cushion 2 is installed on the bottom of the housing body 3. Then, the fiber wire fixation structure 100 assembled as described above is disposed on the repeater cushion 2 thus installed, and the other repeater cushion 2 is further disposed on the fiber wire fixation structure 100. Subsequently, after further preparing a lid 4, the lid 4 is positioned so as to be aligned with the housing body 3.

Then, a pressure is slowly applied downward to the lid 4 so that the two repeater cushions 2 are gradually crushed by the fiber wire fixation structure 100. Finally, when the lid 4 has completely reached the housing body 3, the lid 4 is fixed on the housing body 3, whereby the inside of the optical submarine repeater 1 is sealed. Thus, the assembling of the optical submarine repeater 1 is completed.

As explained above, the fiber wire fixation structure 100 according to the present disclosure is configured so as to include: the rod-shaped fiber cushion (cushion) 10 having the plurality of slits 11 or 12 each extending in the length direction on the outer circumference of the rod-shaped fiber cushion 10, the plurality of slits 11 or 12 being configured so that the fiber wire 200 is allowed to be inserted into each of the plurality of slits 11 or 12; and the cushion fixing part 20 having the hollow tube-shaped structure, the cushion fixing part 20 being configured so that the fiber cushion 10 the cushion is pressed and fixed from the outer circumference of the fiber cushion 10 when the fiber cushion 10 is pressed into the hollow space of the cushion fixing part 20 to the predetermined position in the cushion fixing part 20. By configuring the fiber wire fixation structure 100 in this manner, it is possible to fix the plurality of fiber wires 200 so as to be spaced from each other. This makes it possible to reliably prevent any two or more of the plurality of fiber wires 200 from being compressed and fixed in the optical submarine repeater 1 in a crossed state thereof. Therefore, it is possible to effectively prevent microbending from occurring due to an excessive pressure (pressing) by crossed fiber wires.

Further, the tapered part 21 may be provided at one end in the axial direction of the cushion fixing part 20, the tapered part 21 gradually narrowing toward the other end in the axial direction of the cushion fixing part 20. By providing the tapered part 21 in the cushion fixing part 20, it is possible to assemble the fiber wire fixation structure 100 easily.

Further, the optical submarine repeater 1 of the present disclosure is configured so as to include: the housing 5 having the shape of the rectangular prism, one side of the housing 5 serving as the lid 4; the two flat plate-like repeater cushions (cushions) 2, 2; and the fiber wire fixation structure 100 as described above. In addition, the optical submarine repeater 1 of the present disclosure is configured so that the fiber wire fixation structure 100 is fixed within the housing 5 in a state where the fiber wire fixation structure 100 is pressed by the two repeater cushions 2, 2 from the two directions with respect to the direction perpendicular to the main surface of the lid 4. By configuring the optical submarine repeater 1 in this manner, it is possible to achieve the effects similar to those obtained by using the fiber wire fixation structure 100 while preventing the occurrence of a kink due to pulling on the fiber wire 200.

Moreover, the method of assembling the fiber wire fixation structure 100 according to the present disclosure is configured so as to include: respectively inserting the fiber wires 200 into the plurality of slits 11 or 12 each extending in the length direction of the rod-shaped fiber cushion (cushion) 10, the plurality of slits 11 or 12 being provided on the outer circumference of the rod-shaped fiber cushion 10; and pressing the fiber cushion 10 into the cushion fixing part 20 having the hollow tube-shaped structure to the predetermined position in the cushion fixing part 20 in a state where the plurality of fiber wires 200 is respectively inserted into the plurality of slits 11 or 12. By configuring the method of assembling the fiber wire fixation structure 100 in this manner, it is possible to achieve the similar effects as those obtained by using the fiber wire fixation structure 100.

As described above, the present disclosure has been described with respect to the example embodiments. However, the present disclosure is not limited to the example embodiments described above. Various changes or modifications that can be understood by a person having ordinary skill in the art can be made to the configurations and details of the present disclosure within the scope of the present disclosure.

The drawings are merely illustrative for explaining one or more example embodiments or modification examples. Each of the drawings is not related to only one particular example embodiment, but may be related to one or more other example embodiments. As can be understood by a person having ordinary skill in the art, various features described with reference to any one drawing may be combined with features illustrated in one or more other drawings in order to create example embodiments that are not explicitly illustrated or described. All features illustrated in any one drawing, which is used to describe any example embodiment, are not necessarily essential for the present disclosure. Some features thereof may be omitted.

Although the present disclosure has been explained with reference to the example embodiments, the present disclosure is not limited to the above-described example embodiments, and can be appropriately modified without departing from the gist thereof.

Some or all of the above-described example embodiments may be described as the following supplementary notes, but are not limited thereto.

### (Supplementary Note 1)

A fiber wire fixation structure comprising:
a rod-shaped cushion having a plurality of slits each extending in a length direction on an outer circumference of the rod-shaped cushion, the plurality of slits being configured so that a fiber wire is allowed to be inserted into each of the plurality of slits; and
a cushion fixing part having a hollow tube-shaped structure, the cushion fixing part being configured so that the cushion is pressed and fixed from the outer circumference of the cushion when the cushion is pressed into a hollow space of the cushion fixing part to a predetermined position in the cushion fixing part.

### (Supplementary Note 2)

The fiber wire fixation structure according to supplementary note 1, wherein
the cushion has a cylindrical shape, and
the cushion fixing part has a hollow cylindrical shape.

### (Supplementary Note 3)

The fiber wire fixation structure according to supplementary note 2, wherein
a tapered part is provided at one end in an axial direction of the cushion fixing part, the tapered part gradually narrowing toward the other end in the axial direction.

### (Supplementary Note 4)

The fiber wire fixation structure according to any one of supplementary notes 1 to 3, wherein
a cross section of each of the plurality of slits in a longitudinal direction thereof is a substantially V shape or a substantially U shape.

### (Supplementary Note 5)

The fiber wire fixation structure according to supplementary note 4, wherein
in a state where the outer circumference of the cushion is pressed and the cushion is fixed within the cushion fixing part, the fiber wire inserted into each of the plurality of slits is fixed in the corresponding slit by being pressed from the cross section of the slit without touching the cushion fixing part.

### (Supplementary Note 6)

The fiber wire fixation structure according to any one of supplementary notes 1 to 3, wherein
the fiber wire fixation structure is installed in an optical submarine repeater.

### (Supplementary Note 7)

An optical submarine repeater comprising:
a housing having a shape of a rectangular prism, one side of the housing serving as a lid;
the fiber wire fixation structure according to any one of supplementary notes 1 to 3; and
two cushions having a main surface that is a same main surface of the lid of the housing,
wherein the fiber wire fixation structure is fixed within the housing in a state where the fiber wire fixation structure is pressed by the two cushions from two directions with respect to a direction perpendicular to the main surface of the lid.

### (Supplementary Note 8)

A method of assembling a fiber wire fixation structure, the method comprising:
respectively inserting fiber wires into a plurality of slits each extending in a length direction of a rod-shaped cushion, the plurality of slits being provided on an outer circumference of the rod-shaped cushion; and
pressing the cushion into a cushion fixing part having a hollow tube-shaped structure to a predetermined position in the cushion fixing part in a state where the plurality of fiber wires is respectively inserted into the plurality of slits.

### (Supplementary Note 9)

The method according to supplementary note 8, wherein
the cushion has a cylindrical shape, and
the cushion fixing part has a hollow cylindrical shape.

### (Supplementary Note 10)

The method according to supplementary note 9, wherein
a tapered part is provided at one end in an axial direction of the cushion fixing part, the tapered part gradually narrowing toward the other end in the axial direction, and
the pressing includes pressing the cushion in a state where the plurality of fiber wires is respectively inserted into the plurality of slits into the cushion fixing part from a side of the cushion fixing part at which the tapered part is provided.

### (Supplementary Note 11)

The method according to any one of supplementary notes 8 to 10, wherein
a cross section of each of the plurality of slits in a longitudinal direction thereof is a substantially V shape or a substantially U shape.

### (Supplementary Note 12)

The method according to supplementary note 11, wherein
in the state where the cushion is fixed within the cushion fixing part, the fiber wire inserted into each of the plurality of slits is fixed in the corresponding slit by being pressed from the cross section of the slit without touching the cushion fixing part.

### (Supplementary Note 13)

The method according to any one of supplementary notes 8 to 10, wherein
the assembled fiber wire fixation structure is installed in an optical submarine repeater.

What is claimed is:

1. A fiber wire fixation structure comprising:
a rod-shaped cushion having a plurality of slits each extending in a length direction on an outer circumference of the rod-shaped cushion, the plurality of slits being configured so that a fiber wire is allowed to be inserted into each of the plurality of slits; and
a cushion fixing part having a hollow tube-shaped structure, the cushion fixing part being configured so that the cushion is pressed and fixed from the outer circumference of the cushion when the cushion is pressed into a hollow space of the cushion fixing part to a predetermined position in the cushion fixing part.

2. The fiber wire fixation structure according to claim 1, wherein
the cushion has a cylindrical shape, and
the cushion fixing part has a hollow cylindrical shape.

3. The fiber wire fixation structure according to claim 2, wherein
a tapered part is provided at one end in an axial direction of the cushion fixing part, the tapered part gradually narrowing toward the other end in the axial direction.

4. The fiber wire fixation structure according to claim 1, wherein
a cross section of each of the plurality of slits in a longitudinal direction thereof is a substantially V shape or a substantially U shape.

5. The fiber wire fixation structure according to claim 4, wherein
in a state where the outer circumference of the cushion is pressed and the cushion is fixed within the cushion fixing part, the fiber wire inserted into each of the plurality of slits is fixed in the corresponding slit by being pressed from the cross section of the slit without touching the cushion fixing part.

6. The fiber wire fixation structure according to claim 1, wherein
the fiber wire fixation structure is installed in an optical submarine repeater.

7. An optical submarine repeater comprising:
a housing having a shape of a rectangular prism, one side of the housing serving as a lid;
the fiber wire fixation structure according to claim 1; and
two cushions having a main surface that is a same main surface of the lid of the housing,
wherein the fiber wire fixation structure is fixed within the housing in a state where the fiber wire fixation structure is pressed by the two cushions from two directions with respect to a direction perpendicular to the main surface of the lid.

8. A method of assembling a fiber wire fixation structure, the method comprising:
respectively inserting fiber wires into a plurality of slits each extending in a length direction of a rod-shaped cushion, the plurality of slits being provided on an outer circumference of the rod-shaped cushion; and
pressing the cushion into a cushion fixing part having a hollow tube-shaped structure to a predetermined position in the cushion fixing part in a state where the plurality of fiber wires is respectively inserted into the plurality of slits.

9. The method according to claim 8, wherein
the cushion has a cylindrical shape, and
the cushion fixing part has a hollow cylindrical shape.

10. The method according to claim 9, wherein
a tapered part is provided at one end in an axial direction of the cushion fixing part, the tapered part gradually narrowing toward the other end in the axial direction, and
the pressing includes pressing the cushion in a state where the plurality of fiber wires is respectively inserted into the plurality of slits into the cushion fixing part from a side of the cushion fixing part at which the tapered part is provided.

11. The method according to claim 8, wherein
a cross section of each of the plurality of slits in a longitudinal direction thereof is a substantially V shape or a substantially U shape.

12. The method according to claim 11, wherein
in the state where the cushion is fixed within the cushion fixing part, the fiber wire inserted into each of the plurality of slits is fixed in the corresponding slit by being pressed from the cross section of the slit without touching the cushion fixing part.

13. The method according to claim 8, wherein
the assembled fiber wire fixation structure is installed in an optical submarine repeater.
